(19) United States
(12) Patent Application Publication
(10) Pub. No.: US 2008/0247382 A1
(43) Pub. Date: Oct. 9, 2008

(54) System and method for providing improved VoIP services

(76) Inventors: Rajneesh Verma, Bangalore (IN); Rajeev Khetan, Bangalore (IN); Jithendranath Joijoide Vittalrao, Bangalor (IN)

Correspondence Address: Ralph A. Dowell of DOWELL & DOWELL P.C., 2111 Eisenhower Ave, Suite 406, Alexandria, VA, 22314, US

(21) Appl. No.: 12/010,391

(22) Filed: Jan. 24, 2008

Related U.S. Application Data
(60) Provisional application No. 60/897,063, filed on Jan. 24, 2007.

(51) Int. Cl. H04L 12/66

(52) U.S. Cl. 370/352

(57) ABSTRACT

The invention provides a system and method for providing voice over Internet protocol (“VoIP”) services with an improved quality of service (“QoS”). In one embodiment, a number of gateways or proxies are connected with dedicated links to form a dedicated network. Each gateway is also on one or multiple communication networks, such as individual communication networks provided by different network providers. Each user of the system uses an ATA to connect to the dedicated network, which then connects the user to another ATA of another user, thereby establishing a connection between these two users. The connection between each of the ATAs and the dedicated network is made through communication network or networks. As the quality of a public network is generally not managed by a VoIP service provider, it is desirable to minimize the effects of public network or networks. A method is provided for selecting a gateway that provides the best connection possible to the dedicated network. The selection may be based, for example, network latency. The selected gateway then selects the best receiver gateway for routing the connection request and to connect to the receiver's ATA.

### CROSS-REFERENCE TO RELATED APPLICATIONS

The present application claims priority from U.S. Provisional Application No. 60/897,063 filed on Jan. 24, 2007.

### FIELD OF INVENTION

The invention relates generally to the field of providing communication services. In particular, the invention relates to a system and method for providing voice over Internet protocol (“VoIP”) services with improved quality of service.

### BACKGROUND OF INVENTION

People have been placing telephone calls using Public Switched Telephone Network (“PSTN”) systems, or through private branch exchanges (“PBXs”), or other circuit-switching based communications networks. Such circuit-switching based systems establish a dedicated, end-to-end circuit between a source and a destination for the duration of the telephone communication so that telephony signal (whether analog or digital, whether voice or otherwise) can be transmitted over the dedicated circuit.

More recently, people have turned their attention and interests to telephony services provided through voice over Internet protocol (“VoIP”) technologies. In general, a telephony interface device, such as an Internet phone or an analog telephone adaptor (“ATA”), is used for making a VoIP phone call. A telephony interface device is a device used for connecting to the Internet and receiving VoIP services. It converts a voice signal detected by a microphone, typically an analog signal, to a digital coding signal suitable for transmission over the Internet. This conversion is generally carried out by a special coder-decoder (“codec”). The digital coding signal is broken into data packets. These data packets are transmitted over the Internet, following Internet data transport protocols. When the packets arrive at the receiver's end, the packets are reassembled to form the initial digital coding signal. Another codec at the receiver's end converts the digital coding signal back to an analog signal. The restored analog signal is then provided to receiving party's headset or other electrical/mechanical device to reproduce the audio output.

Unlike a traditional PSTN session, a VoIP session does not require a dedicated, end-to-end circuit. The transmission of voice signals follows the Internet protocols, which are based on data packet switching. Although a connection is still established between two users, the transmission of data over the established connection is generally through physical wiring shared with others utilizing the same wiring for transmitting other data. No dedicated, end-to-end circuit is required for carrying out telephone communication. This promotes efficient utilization of physical data transmission lines.

VoIP technologies offer the potential of a number of other advantages, too. VoIP technologies can take advantage of a more robust data network provided by the Internet and redundant packet network transmission to promote reliability and availability of voice communications. In addition, other techniques such as data compression may also be employed, to further increase utilization efficiency of physical wiring. VoIP technologies generally require less bandwidth compared to telephone services using traditional PSTN networks and may have a lower cost. VoIP technologies also permit easier integration of transmission of graphics or video data along with audio signal.

However, quality of service (“QoS”) of VoIP communications is not always optimal. The Internet was initially developed primarily as a data network. Its data transmission is based on packet-switched data transmission. This type of data transmission is not optimal for transmitting real-time data such as voice signals of phone conversations. For example, quality of voice communication may suffer from dropped connections, delays caused by congestion of network traffic, or caused by any intermediate computer hosts making up the connection between the caller and the recipient, and from lost data packets, among others. Thus, a telephone conversation facilitated by a VoIP connection may appear to have discernible delays, may be jittery, and may suffer from lost signal. These quality concerns tend to discourage people from utilizing VoIP services, a technology which may potentially offer other advantages. In addition, interoperability between the Internet and a legacy network, to which a VoIP user connects to reach PSTN users, also presents further difficulties.

Many solutions have been proposed to improve QoS of VoIP services. For example, buffers (“jitter buffers”) may be provided to remove some of the jitters created due to the nature of a packet-switched network. To remove all the jitters, however, may be a challenge, or impossible. There have also been proposals to implement certain mechanisms to recreate or guess dropped data packets. But they cannot recover all dropped data packets. Another proposal for providing quality VoIP services is to select codec depending on the quality of network connectivity and routes taken by the data packets. The objective of this approach is to select a particular codec better suited for a given situation depending on, for example, the quality of network connectivity or routes taken by data packets. However, while one codec may be suitable for one condition, there is not a codec that generally works well for all conditions. Of course, there have also been solutions that use dedicated lines, i.e., leased line circuits. These solutions, while may help improve QoS in some situations, may not be effective in other situations. Some may also be very expensive to implement or operate.

The forgoing creates challenges and constraints for providing VoIP services that maintain a consistent and acceptable QoS. There is therefore a need for an improved system and method for providing VoIP services as compared to the existing art. It is an object of the present invention to mitigate or obviate at least one of the above mentioned disadvantages.

### SUMMARY OF INVENTION

The invention relates to a system and method for providing voice over Internet protocol (“VoIP”) services with an improved quality of service (“QoS”). It also provides the benefits of redundancy, increased availability and wireless-VoIP inter-operability, which can be achieved with the integration of user customized hardware enabling landline connectivity and multiple proxy servers each of which has connection to multiple networks. In one embodiment, a number of gateways or connection nodes are provided. These gateways are connected with data links having acceptable transmission quality to form a dedicated network. Each gateway is also on one or multiple communication networks, such as individual communication networks provided by different network providers. Each user of the system uses a telephony interface device (such as an ATA or software application executing on a computation device) to connect to the gateway, thereby gaining access to the dedicated network, which then connects the user to another ATA of another user, thus establishing a connection between these two users. The other user, namely the receiver, may be a legacy user connected to the system through PSTN termination gateways (e.g., a PSTN subscriber). The connection between an ATA and the dedicated network is made through a communication network or a number of (public) networks originating from the network on which the ATA first connects. As the transmission quality of a public network is generally not managed by a VoIP service provider, it is desirable to minimize the effects of public network or networks to the quality of service of the overall connection between users. A method is provided for selecting a gateway that provides the best connection available to the dedicated network. The selected gateway then identifies and connects to the best receiver gateway selected by the receiver for routing the connection request and connecting to the receiver's ATA. The selection method may be based on criteria such as network latency, data packet loss rate, number of hops between an ATA and the gateway, among others.

In a first aspect of the invention, there is provided a system for providing VoIP services in a network of interconnected telecommunication networks for a caller to carry out telephony communications with a recipient. The system includes a plurality of interconnected connection nodes forming a dedicated network, each of the connection nodes being connected to at least one other connection node with a data communication link meeting a transmission quality standard and being a member of at least one of the telecommunication networks, an initiating telephony interface device for the caller and a receiving telephone interface device for the recipient for carrying out the telephony communications through a media stream path including a middle segment through the dedicated network, a first connection node selector for selecting a first connection node from the plurality of connection nodes, a first segment of the media stream path between the first connection node and the initiating telephony interface device satisfying a first quality criteria, and a second connection node selector for selecting a second connection node from the plurality of connection nodes, a second segment of the media stream path between the second connection node and the receiving telephony interface device satisfying a second quality criteria. The media stream path comprises the first segment, the middle segment and the third segment.

In another aspect of the invention, there is provided a method of providing VoIP services to users in a network of interconnected telecommunication networks. The interconnected networks include a plurality of connection nodes interconnected with communications links to form a dedicated network, the communication links meeting a predetermined quality standard. Each of the plurality of connection nodes being members of at least one of the telecommunication networks. The method includes the steps of: receiving a request for establishing a VoIP session from a caller telephony interface device, the VoIP session request including a receiver identifier for uniquely identifying a recipient, selecting a first connection node from the plurality of connection nodes, a first data connection between the first connection node and the caller telephony interface device satisfying a first quality criteria, identifying a second connection node among the plurality of connection nodes, a second data connection between the second connection node and a recipient telephony interface device satisfying a second quality criteria, a communication link between the first connection node and the second connection node forming an intermediate data connection; and establishing the VoIP session between the caller telephony interface device and the recipient telephony interface device, the VoIP session being carried out over a media connection path formed from the first data connection, the intermediate data connection and the second data connection.

In another aspect of the invention, there is provided a system for providing VoIP services to users in a network of communication networks. The system includes a plurality of interconnected connection nodes forming a dedicated network, each of the connection nodes being connected to at least one other connection node with a data communication link meeting a transmission quality standard and being a member of at least one of the telecommunication networks; a caller ATA for requesting a VoIP session, the caller ATA being connected to a first communication network of the communication networks; a receiver ATA for receiving a VoIP request, the receiver ATA being associated with a unique receiver identifier; a database for storing receiver account information, the receiver account information including records of the unique receiver identifier; a caller connection node selector for selecting a first connection node from the plurality of connection nodes, a first segment of the media stream path between the first connection node and the caller ATA satisfying a first quality criteria; and a forwarding connection node selector for selecting a forwarding connection node from the plurality of connection nodes, a second segment of the media stream path between the forwarding connection node and the receiver ATA satisfying a second quality criteria, the second connection node having a registry identifying the receiver ATA to be registered with the forwarding connection node.

In yet another aspect of the invention, there is provided a method of providing VoIP services to users in a network of interconnected telecommunication networks. The network has a dedicated network formed from a plurality of connection nodes interconnected with communications links, the communication links meeting a predetermined quality standard, each of the plurality of connection nodes being members of at least one of the telecommunication networks, the users operating telephony interface devices connected to the telecommunication networks. The method includes the steps of for each telephony interface device, periodically associating a connection node from the plurality of connection nodes with the telephony interface device, a data connection between the connection node and the each telephony interface device satisfying a first data transmission quality criteria, upon receiving a request for establishing a VoIP session between a caller and a recipient from a caller telephony device, the recipient being identified by a recipient identifier, identifying a caller connection node associated with the caller telephony device, identifying a recipient connection node based on the recipient identifier, identifying a recipient telephony interface device associated with the recipient node, establishing a first data connection between the caller telephony device and the caller connection node, an intermediate connection between the caller connection node and the recipient connection node, and a second data connection between the recipient connection node and the recipient telephony interface device, and establishing the VoIP session between the caller telephony interface device and the recipient telephony interface device, the VoIP session being carried out over a media stream path formed from the first data connection, the intermediate data connection and the second data connection.

In other aspects the invention provides various combinations and subsets of the aspects described above.

### BRIEF DESCRIPTION OF DRAWINGS

For the purposes of description, but not of limitation, the foregoing and other aspects of the invention are explained in greater detail with reference to the accompanying drawings, in which:

FIG. 1 is a schematic diagram that provides an overview of an exemplary architecture of a system for providing improved VoIP services according to an embodiment of the present invention;

FIG. 2 illustrates schematically a connection path between two users of the system shown in FIG. 1;

FIG. 3A is a schematic diagram showing in detail a configuration of a gateway of the system of FIG. 1;

FIG. 3B is a schematic diagram showing in detail another configuration of a gateway of the system of FIG. 1;

FIG. 4A illustrates schematically a connection path between two users provided by the gateway shown in FIG. 3A;

FIG. 4B illustrates schematically a connection path between an ATA and a PSTN telephone in a system including a gateway shown in FIG. 3B;

FIG. 5 is a block diagram illustrating schematically several components of an ATA for use in a system, such as the system shown in FIG. 1, of the present invention;

FIG. 6 is a block diagram showing components of a software system for facilitating VoIP calls between users of the system shown in FIG. 1;

FIG. 7 is a flow chart illustrating a process executed by the ATA shown in FIG. 5 to identify a suitable proxy server;

FIG. 8 is a flow chart showing a latency procedure that can be incorporated in the process illustrated in FIG. 7 for locating the fastest proxy server; and

FIGS. 9 and 10 illustrate schematically a process for establishing a connection path between two users of the system shown in FIG. 1.

### DETAILED DESCRIPTION OF EMBODIMENTS

The description which follows and the embodiments described therein are provided by way of illustration of an example, or examples, of particular embodiments of the principles of the present invention. These examples are provided for the purposes of explanation, and not limitation, of those principles and of the invention. In the description which follows, like parts are marked throughout the specification and the drawings with the same respective reference numerals.

The present invention relates to a system and method for providing VoIP services. In one preferred embodiment, a number of connection nodes (or gateways or proxies) are connected with dedicated links to form a dedicated network. Each connection node is also on one or multiple public communication networks, such as tier-1 communication networks provided by major carrier operators. The dedicated network and the public communication networks are packet-switched networks. Each user of the system uses a telephony interface device (such as an ATA or a software application executing on a computation device) to connect to the dedicated network, which then connects the user to another ATA of another user, thereby establishing a connection between these two users. The connection between each of the ATAs and the dedicated network is made through a public communication network or networks. As the quality of the public sections of the network connection generally is neither managed nor controllable by a VoIP service provider, it is desirable to minimize any deleterious impact of the public network sections on the QoS of a VoIP connection. A method is provided for selecting a first gateway, i.e., an ingress gateway, that provides the best connection available to the dedicated network at a given time from a caller's ATA. The selected ingress gateway then selects the best receiver gateway, or egress gateway, for routing the connection request and to connect to the receiver's ATA. Thus, the QoS of a VoIP session between two ATA's can be maintained at a consistent level.

In the description provided herein and that follows, an ATA will be used as an example of a telephony interface device for connecting to the network and for initiating or receiving phone calls. However, it will be appreciated that the description equally applies to VoIP sessions using any other telephony interface device for connecting to the network and converting a voice signal between analog and a suitable digital coding format for transmission over the Internet.

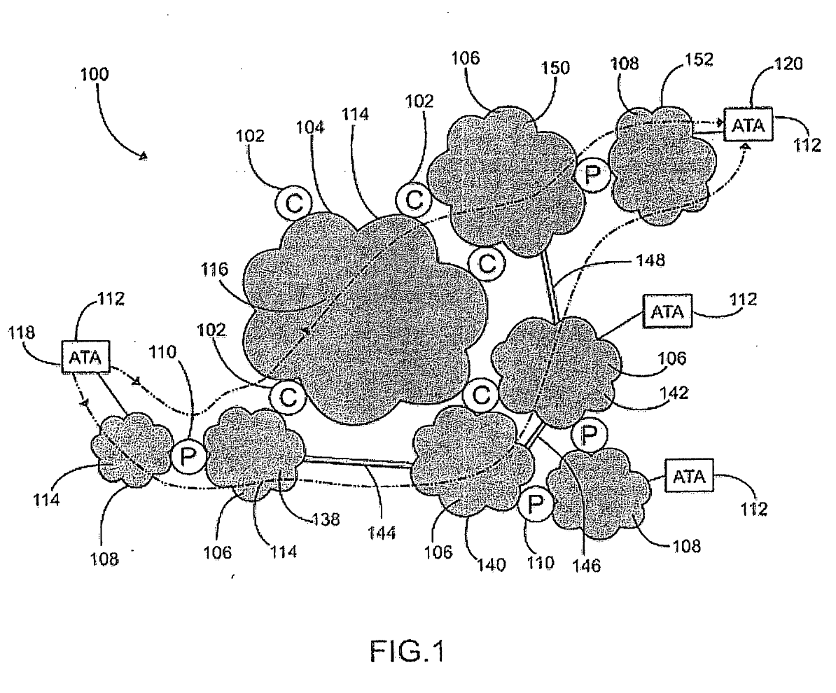

FIG. 1 is a schematic diagram that provides an overview of an exemplary architecture of a system 100 for providing improved VoIP services according to an embodiment of the present invention. The system 100 has a number of connection nodes in the nature of gateways 102, or proxy servers. High quality data links (not shown) between and among these gateways 102, such as dedicated MPLS (Multiprotocol Label Switching) data links, connect these gateways 102 together to form a dedicated network 104. The connection nodes, or gateways 102, provide connection points for a user to connect to the dedicated network 104.

Each gateway 102, in addition to being directly on the dedicated network 104, is also on at least one major carrier network, or tier-1 network 106. An individual network operator or internet service provider (“ISP”) provides public access to a tier-1 network 106 though its own network, or ISP network 108. An ISP network 108 connects its users to a tier-1 network 106 through a connection point, such as a public or private peering 110. A user operates an ATA 112, which connects to the user's ISP's network 108, which, in turn, connects to a tier-1 network 106 through the public/private peering 110. The gateway 102, which may be a private peering between the tier-1 network 106 and the dedicated network 104, finally connects the user to the dedicated network 104.

As is understood by those skilled in the art, the Internet is a worldwide, publicly accessible network that is formed from a large number of interconnected computer networks, such as major carrier networks 106, dedicated network 104, and ISP networks 108, as well as other networks (collectively, “interconnected telecommunication networks”). Each individual telecommunication network 114 may be independently operated, such as by an individual network operator, an internet service provider, or a major carrier operator. Some examples of major carrier networks include those provided by Level 3 Communications, Inc., Verizon Communications Inc., and Global Crossing Limited. ISP networks are generally provided by local ISP companies, though sometimes, an ISP company may be national and provide internet access to subscribers in several provinces or states of a country.

Each telecommunication network 114 is usually allocated a range of IP addresses. Each network device connected to the telecommunication network is assigned an IP address within this range. An IP address uniquely identifies a network device on the Internet so that the network device can be located by other network devices. Currently, an IP address has the form a.b.c.d where each of a, b, c, d is a number between 1 and 255. The first number, a, or a combination of the first several numbers, such as a.b, generally is used to designate an individual network connected to the Internet. Any network device, such as a gateway, is said to be directly connected to a network, i.e., on the network, when the network device has an IP address that belongs to the range of IP addresses assigned to the network. For example, when a communication network is allocated an IP address range 123.231.1.1-255, and a gateway has an IP address 123.231.1.111, the gateway is said to be on the communication network because its IP address is within the range of the network's assigned IP address range. Similarly, when a device or computer host possesses multiple IP addresses each of them belonging to a range of IP addresses assigned to a separate communication network, the device or computer host is said to be on these communication networks simultaneously. In general, a device or computer host may be directly on several communication networks.

Typically, a user of the system accesses the system and receives VoIP services using a telephony interface device. A telephony interface device may be hardware based, software based, or a combination thereof. For example, a user may use an analog telephone adapter, or ATA 112, to connect to the system. Alternatively, a user may use a “softphone”, i.e., a software application executing on a personal computer or other computation hardware device, to simulate a hardware telephone and an ATA for receiving VoIP services. More generally, any networking device with the appropriate functionality, whether implemented as software or hardware, or a combination thereof, can be used for this purpose.

Although FIG. 1 shows only a few different communication networks 114, it will be appreciated that the Internet consists of a very large number of interconnected individual public networks and private networks. It will also be appreciated that each constituent network may span vast geographical distances. Accordingly, the system shown in FIG. 1 may be interfaced with a large number of networks and an ATA connected to any one of these networks is not necessarily located in geographical proximity with another ATA connected to the same network. Conversely, ATAs connected to different communication networks may actually be located in the same city, or the same neighborhood.

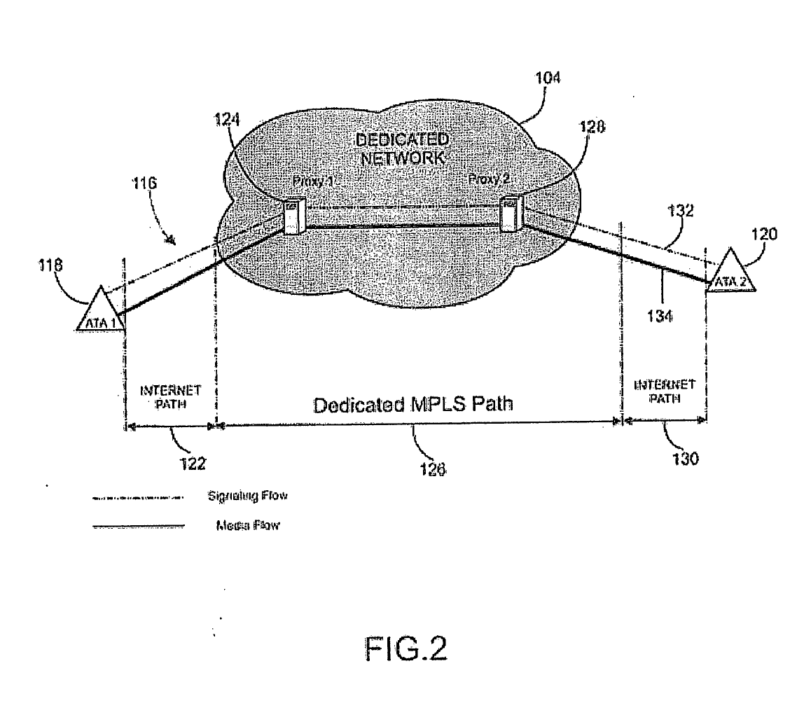

Referring to FIG. 2, there is shown in detail a connection path 116 between an initiating ATA 118 and a receiving ATA 120. The connection path 116 has essentially three sections. A first section 122 connects the initiating ATA 118 to a first connection node 124, and thereby to the dedicated network 104. An intermediate section 126 connects the first connection node 124, an ingress gateway to the dedicated network, to a second connection node 128, an egress gateway to the dedicated network. A second section 130 in turn connects the second connection node 128 to the receiving ATA 120.

Both the first and second sections are generally provided by third party network operators, such as ISPs (or tier-1 network operators). Generally, neither consistent nor stringent quality standard is imposed with a view to providing voice data transmission over these two sections. As will be described in great detail later, the present invention attempts to select “shortest” or “best” possible first and second sections with a view to improved voice data transmission quality.

The intermediate section 126 linking the first connection node 124 and the second connection node 128 is provided by the dedicated network 104. All links between any pair of connection nodes in the dedicated network 104, including the link between the first connection node 124 and the second connection node 128, are required to meet a minimum quality standard. The links may be privately leased connections to ensure satisfactory connection quality. Preferably, links between gateways of the dedicated network are MPLS links. MPLS is a switching protocol that integrates Layer 2 switching with Layer 3 routing and is also known as a “Layer 2.5 protocol”. Under MPLS, routing is not determined by destination IP address. Instead, an MPLS-enabled network routes encapsulated IP packets based on origination and destination priority, therefore overriding IP's “shortest path” or “best effort” routing mechanism. A priority-based routing mechanism tends to make QoS routing more efficient and help reducing jitter, packet losses and other undesirable quality losses. As the impact of the first and second sections on quality of service is minimized and the intermediate section is required to meet a minimum quality standard, the overall data transmission quality tends to be improved and becomes controllable.

As is known to those skilled in the art, providing a VoIP connection from the initiating ATA 118 to the receiving ATA 120 generally involves establishing two paths, a signaling path 132 and a media stream path 134. The signaling path 132 allows the ATAs to signal to each other to coordinate their actions to transmit and receive data packets corresponding to voice data so that users can connect and make phone calls. Media stream path 134 is actually responsible for transporting the data packets from one ATA to another ATA. Although FIG. 2 shows that the same connection path 116 provides both the signaling path 132 and the media stream path 134, it will be understood that it is not necessary. Signaling path and media stream path do not have to share the same connection path. The connection path 116 is for providing a reliable and high-quality media stream path 134 on the dedicated network, such as an MPLS network.

The example shown in FIG. 2 should be contrasted to situations in which an initiating ATA 118 connects to its destination entirely through public networks operated by major carriers and/or ISP operators. Referring to FIG. 1, the initiating ATA 118 may connect to its ISP's network 108, which connects, through a series of intermediate tier-1 networks 138, 140, 142 and internetwork connections 144, 146, 148, to a destination tier-1 network 150. The recipient's ISP network 152 finally completes the connection between the destination tier-1 network 150 and the destination ATA 120, or receiving ATA 120. As will be appreciated, because this entire alternative connection path is through public networks, none of which is managed nor controlled by a VoIP service provider, the VoIP service provider generally has no control over the data transmission quality of such an alternative connection path.

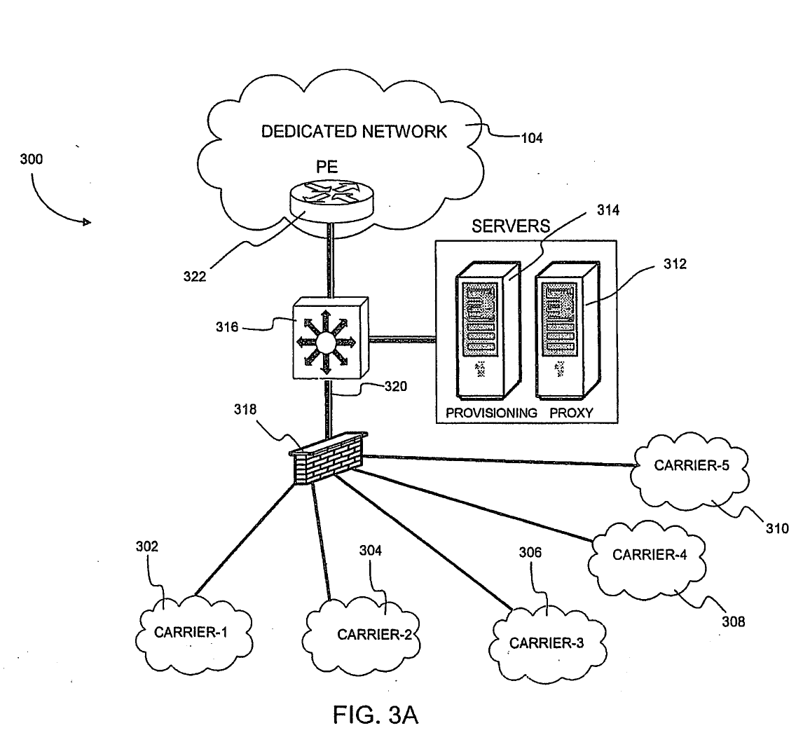

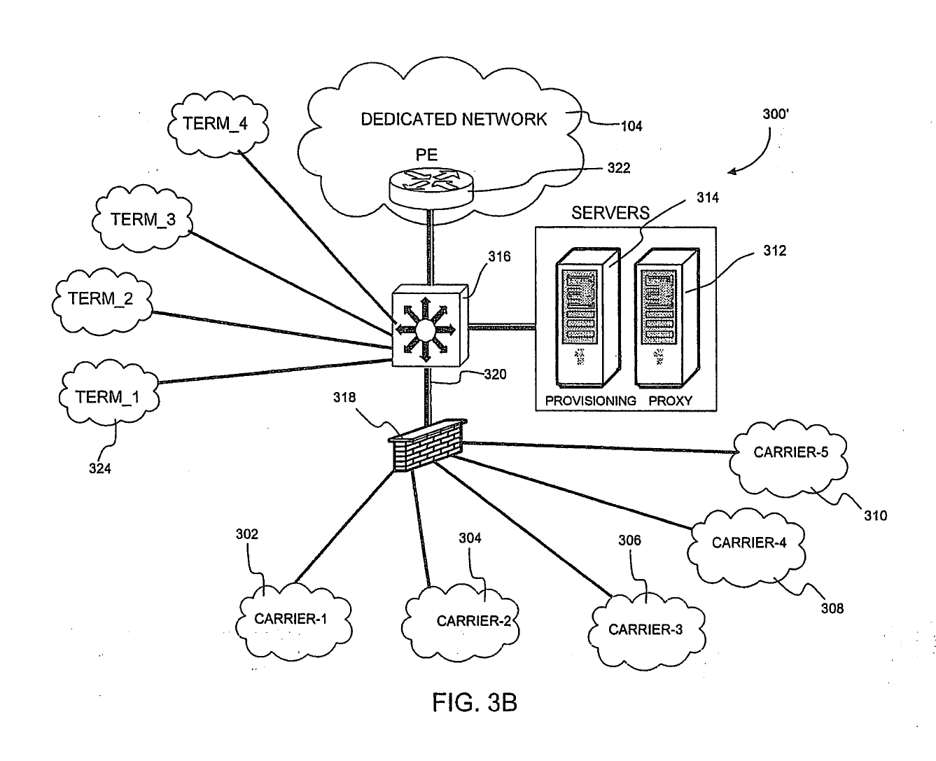

Referring to FIG. 3A, there is shown schematically a gateway 102 (or point of presence of VoIP service provider, VoIP POP 300). A VoIP POP is generally provided at a site, or location to serve users in surrounding geographic regions. As will be remembered, a VoIP POP is on the dedicated network 104 and another telecommunication network 114, such as a tier-1 network. A user connects to the VoIP POP to gain access to the dedicated network 104. Each POP provides a gateway for users to connect to the dedicated network, i.e., functioning as a connection node on the dedicated network 104.

FIG. 3A shows several components of the gateway, or VoIP POP 300. The VoIP POP 300 shown in FIG. 3A is connected to five different tier-1 carrier networks, shown as carrier-1 network 302, carrier-2 network 304, carrier-3 network 306, carrier-4 network 308 and carrier-5 network 310. As described earlier, a gateway is directly connected to a network if it has an IP address that belongs to a range of IP addresses allocated to the network. For example, the carrier-1 network 302 may have an IP address range 121.x.y.1-121.x.y.255, the carrier-2 network 304 may have an IP address range 123.x.y.1-123.x.y.255, and the network carrier-3 network 306 may have an IP address range 125.x.y.1-125.x.y.255. Here, x, y may be any number within the rage 1-255. The VoIP POP 300 may have three different IP addresses, 121.x.y.3, 123.x.y.50 and 125.x.y.75, so that network devices on any one of these communication networks can communicate directly with the VoIP POP 300 through a peer-to-peer connection within one single network.

A VoIP POP 300 includes a number of components, such as proxy server 312, provisioning server 314, and other network connection elements such as network switch 316, firewall 318, broadband links 320 and service provider's edge router, or PE 322, though not all VoIP POPs require all of these components. For example, some VoIP POPs may not include a provisioning server so that several VoIP POPs may share one provisioning server.

The proxy servers process connection requests from users and handle the requests on behalf of the users. For example, when a caller wishes to connect to a remote user, the caller sends the connection request to one of the proxy servers 312. The proxy server 312 processes the request, locates a remote proxy server for the remote user, and connects to the remote proxy server that in turn connects to the remote user, to complete the connection. The provisioning server 314 is a server that provides connecting ATA with the necessary information when requested so that the ATA can authenticate to its registered proxy server. In FIG. 3A, only a proxy server and a provisioning server are shown, though it should be understood that each site, or VoIP POP, may have as many proxy servers as desirable or necessary. In addition, not all VoIP POPs include a provisioning server. To keep the system operational, the only requirement is that there are sufficient number of provisioning servers to satisfy provisioning information requests from all ATAs. The actual number of proxy servers (and provisioning servers) at any given site is determined by a number of factors, load factor being one of them

A network switch 316 connects the proxy server 312 and provisioning server 314 to tier-1 networks, such as carrier-1 network 302, and to the dedicated network 104. For security, a firewall 318 is provided between the network switch 316 and access points for connecting to external communication networks. Alternatively, a router (not shown) may be used between the switch and the tier-1 networks, for directing network traffic to different tier-1 networks. The router can also perform the functions of a firewall. For improved performance, high speed, high reliability, broadband links 320 connect the network switch 316 to the firewall 318, the proxy server 312, the provisioning server 314, and a provider's edge router, or PE 322, that resides on the border of the dedicated network 104.

FIG. 3B shows another configuration of a VoIP POP 300′. The VoIP POP 300′ shown in FIG. 3B is otherwise the same as the VoIP POP shown in FIG. 3A, except that its network switch 316 provides additional interfaces for connections to PSTN termination (or origination) gateways 324. PSTN termination or origination gateways 324 are entry points to local PSTN networks. They allow VoIP users to communicate with users on plain old telephone system (“POTS”). A PSTN termination gateway, for example, accepts a request to connect to a recipient from a proxy server 312, locates the recipient, and allocates a circuit from the termination gateway to a POTS user for voice communication. When the allocated circuit is set up, the VoIP user will be able to speak to the POTS user. Four PSTN termination gateways 324 are shown, though it will be understood that any suitable number of PSTN termination gateways (or origination gateways) are possible. The VoIP POP 300′, by including PSTN termination gateways 324, allows a user to connect to a PSTN telephone number that is not otherwise bridged to the VoIP network.

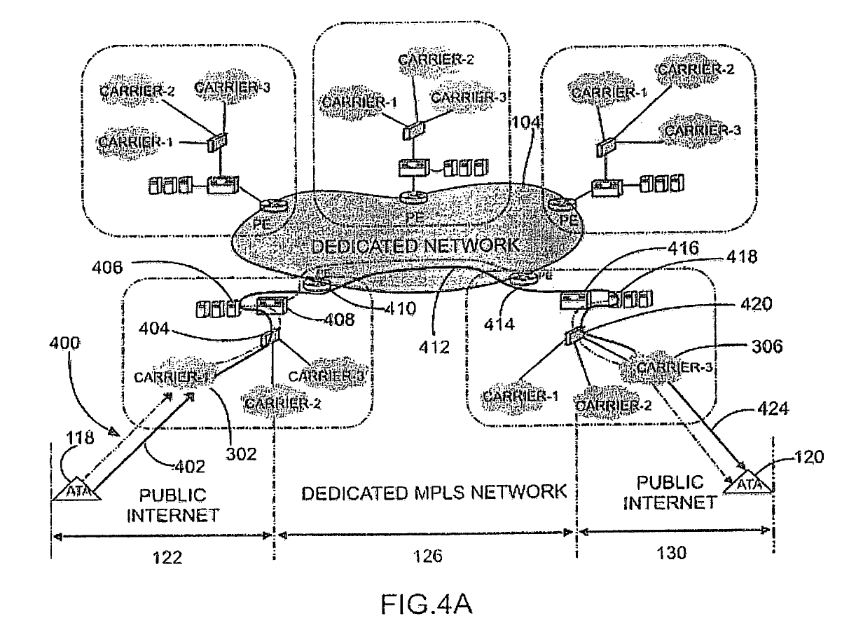

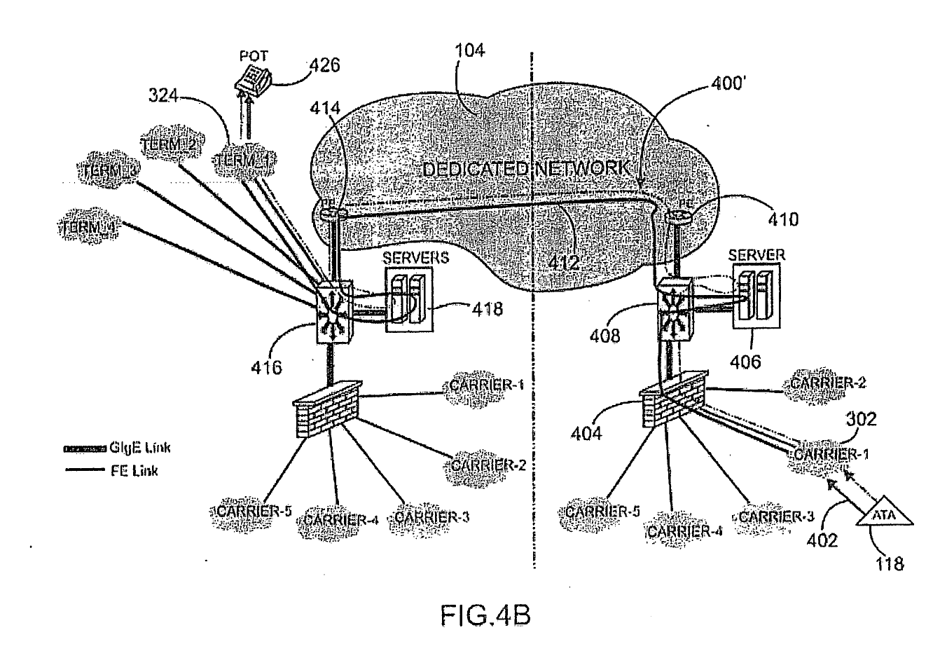

Now referring to FIG. 4A, there is shown the network infrastructure 100 and a connection 400 overlaid therewith. The network infrastructure shown in FIG. 4A is essentially the same as that shown in FIG. 1, except that the diagram shows more details of each gateway but no details of the connections provided by ISPs. An initiating ATA 118 is connected to a tier-1 network, such as carrier-1 network 302, through a public IP connection path provided by the caller's ISP network (not shown in FIG. 4A). A receiving ATA 120 is connected to another tier-1 network, such as carrier-3 network 306, again through a public IP connection path provided by the recipient's ISP network (not shown in FIG. 4A). The media path 400 passes through the following elements: the initiating ATA 118, a first public IP segment 402, carrier-1 network 302, first firewall 404, first proxy server 406, first network switch 408, first PE 410, a dedicated path 412 from first PE 410 to another, or second PE 414 at the receiver's end of the dedicated network 104, a second network switch 416, second proxy server 418 at the receiver's end, a second firewall 420 in the recipient proxy server 418, the carrier-3 network 306, and then through a second public IP segment 424 to the receiver's ATA 120. The first section 122, between the initiating ATA 118 and the first firewall 404, is made up of the first IP segment 402, generally provided by the caller's ISP, and carrier-1 work 302. The intermediate section 126 of the media path 400 is the portion of network connection between the first firewall 404 at the initiating user's end and the second firewall 420 at the receiver's end. This is the dedicated network portion. The second section 130 is the network connection between the second firewall 420 at the receiver's end and the receiver's ATA 120. This section is provided by the carrier-3 network 306 and the second public IP segment 424, generally provided by the recipient's ISP.

A connection path like the media path 400 shown in FIG. 4A tends to minimize the impact on QoS caused by the first and second sections, namely, the network sections generally neither managed nor controllable by a VoIP service provider. This becomes possible because the connection selects an optimum caller proxy server 406 and an optimum recipient proxy server 418, which both are required to meet a quality standard, or are the ones that provide the best quality possible among all available proxy servers.

A connection path from an initiating ATA to a PSTN user, or a receiver's plain old telephone (“POT”), is similar to that shown in FIG. 4A. This is shown in FIG. 4B. The connection 400′ from the initiating ATA 118 to the recipient proxy server 418 is the same as before. However, instead of routing the call to the receiver's ATA, which the receiver does not have, the call is routed to a PSTN termination gateway 324, which then connects to the receiver's POT 426 to complete the connection path.

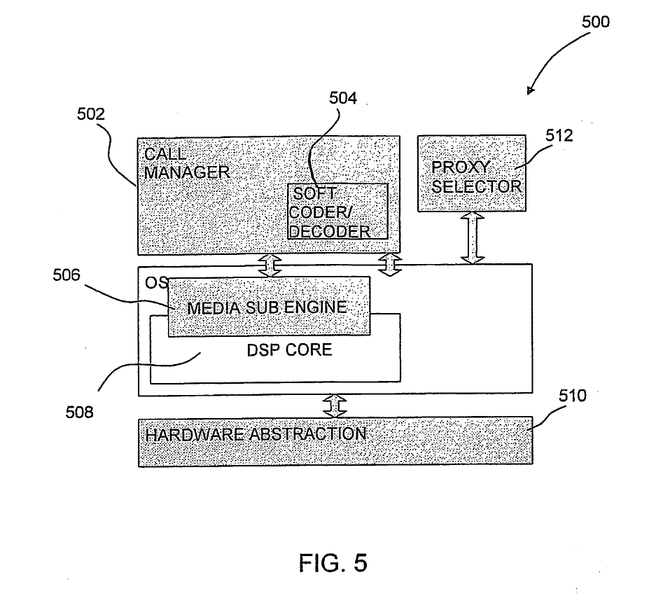

FIG. 5 is a block diagram showing a modified ATA 500 with the added functionality for locating a suitable POP, or proxy. The modified ATA 500 has a call manager 502, a soft coder/decoder 504, a media subengine 506, a DSP core 508, hardware components 510, and a proxy selector 512.

The call manager 502 coordinates and directs the operation of other units and allocates resources of the different units depending on specifics of a telephone call. It determines, for example, whether a call should be routed to a SIP (session initiated protocol) proxy or another type of connection and allocates the resources accordingly. If data needs to be decoded or encoded, or if the media data needs to be converted from one type, such as SIP, to another type, such as TDM (time division multiplex), the call manager 502 directs the appropriate units, such as coder/decoder 504, media subengine 506, or DSP core 508, to carry out the required operations. The codec, or soft coder/decoder 504 is responsible for coding and decoding media stream (e.g., the voice part of a phone call) and converts media stream data into appropriate data formats. The media subengine 506 is a software application or process that takes care of signal manipulation (such as processing of voice or speech signal) under the command of the call manager 502. The DSP core 508 is a digital signal processing unit, typically a dedicated part of a central process unit (“CPU”) (or a CPU by itself). The DSP core 508 provides the functionality of performing multiple concurrent speech coding and decoding operations. The hardware components 510 represent hardware circuitry, circuit components and board connections that make physical connections with digital data networks and the PSTN.

In addition, the modified ATA 500 includes a proxy selector 512. Proxy selector 512 has a memory device (not shown) for storing an IP address of a centralized database server, such as a dedicated DNS server, from which the proxy selector 512 can request and obtain a list of IP addresses of all proxy servers; alternatively, IP addresses of all proxy servers or gateways 102 on the dedicated network 104 may be stored on the memory device for faster access. The proxy selector 512 uses a set of network and VoIP analysis tools to test and measure the quality of connections from the modified ATA 500 to each one of the proxy servers of a VoIP service provider or VoIP service providers. The proxy server that provides the best quality of connection is selected for connection to the dedicated network 104. After the best proxy server is selected, the proxy selector 512 also contacts both the best proxy server and a central database server to register the ATA 500 with the selected proxy server, as will be described in detail later. The IP address of the selected proxy server may also be stored locally in the memory device included in the ATA. This selection-registration process will be described in great detail below. Generally, this process is performed when an ATA is first powered on, or connected to the Internet, or registered to the system. Alternatively, this process can be performed each time a request to make a VoIP telephone call is received. Preferably, this process is repeated on a recurrent basis as a compromise that the best proxy server is most likely selected and a fast connection is ensured. When the modified ATA 500 receives a user request to make a phone call, it routes the request to the selected proxy server.

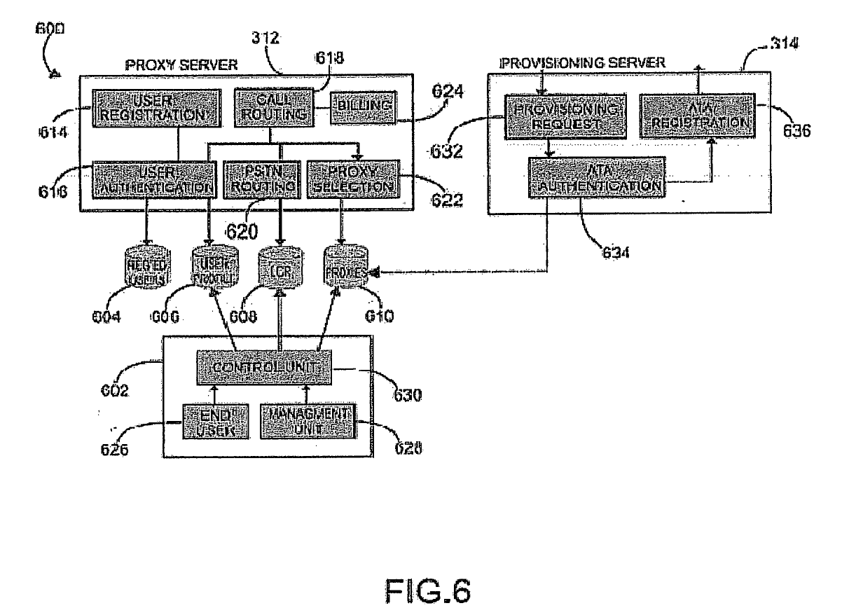

FIG. 6 illustrates schematically the architecture of a software system 600 for providing an improved VoIP services over the network connections shown in FIG. 1. Conceptually, the software system 600 is divided into a proxy server 312, a provisioning server 314, a central management server 602, and a number of databases including registered user database 604, user profile database 606, LCR database 608, and proxy registration database 610. These units may be a separate software or firmware component, or may be a software process executing on a computer. As will be further appreciated, although separate databases are referenced here, these databases may be combined into one, or may be components of a centralized database, or may constitute part of a distributed, consolidated database, as long as the required database functionality is provided.

The proxy server is provided for handling routing logic, such as user interconnection, least call routing (“LCR”), or voicemail access. Conveniently, the proxy server 312 can be implemented as a Session Initiation Protocol (SIP) proxy. FIG. 6 shows six major components of proxy server 312: user registration unit 614, user authentication unit 616, call routing unit 618, PSTN routing unit 620, proxy selection unit 622 and billing unit 624.

User registration unit 614 registers a user with the proxy server, namely to associate a user's user identifier with the proxy server 312. User registration also associates an IP address of the user's ATA with the proxy server. Thus, after a user is registered with a proxy server, a request to connect to the user will be routed to the registered proxy server. The proxy server will in turn route the request to the user in accordance with the IP address registered with the proxy server. Information gathered or received during user registration is stored in the registered user database 604, accessed through the user authentication unit 616. The user registration process can also take the opportunity to double check if a user requesting access to a proxy server is a known user, i.e., a user subscribed to the VoIP services, and cross check information received from the user with that stored in the registered user database 604 and the user profile database 606.

User authentication unit 616 accesses both registered user database 604 and user profile database 606 and uses the authentication data stored in these databases to authenticate a user. For example, the user authentication unit 616 may authenticate a user using the user supplied unique user identifier and a password. A user may also be authenticated by the user's PSTN telephone number or the user's mobile phone number. For added security or alternatively, a password may be assigned to the phone numbers and be required from the user when authenticating the user. User authentication unit 616 also provides an interface to registered user database 604 and user profile database 606. When requested by either user registration unit 614 or call routing unit 618, user authentication unit 616 retrieves and forwards registered user data or user profile data, such as the user's registered IP address, PSTN phone number or mobile phone number, unique user identifier or password, on behalf of user registration unit 614 or call routing unit 618.

Call routing unit 618 determines how a call request should be routed. It determines first the “location” of the recipient. A call request includes a destination such as a telephone number or a recipient's user identifier. The call is routed to a proxy server serving the destination. If a destination telephone number does not correspond to that of a subscription customer, it is presumed that the call should be routed to a PSTN termination gateway. The call may also be routed to a PSTN termination gateway if an IP connection to a subscription customer cannot be established, for example, when the customer's telephony interface device is not switched on or not connected to the customer's ISP network.

When a call is to be routed to a PSTN termination, call routing unit 618 hands the request to PSTN routing unit 620, which then accesses the LCR database to determine a suitable PSTN termination gateway based on a pre-established rule or rules. For example, the PSTN call may be routed to a PSTN termination gateway that would provide the best connection quality available at that time, or to a PSTN termination gateway that would provide the cheapest rate to the PSTN user. If the destination is to a telephone number of a subscription customer or a user identifier of a subscription customer, the call routing unit 618 hands the call request to the proxy selection unit 622.

Proxy selection unit 622 uses data in proxy registration database 610 to find the proxy to which the recipient is registered. The proxy registration database 610 keeps records of proxies to which all system users have registered. The records associate each of the system users' user identifiers with a proxy server, namely the user's registered proxy server. Also associated with the user's registered proxy server is a registered IP address of the user's telephony interface device. It will be understood that a user may be registered with multiple proxies, for example, because the user has multiple telephony interface devices. These multiple telephony interface devices may not be connected to the same network. It is possible that different telephony interface devices are registered to different proxy servers, for example a “home” ATA registered to one local proxy and one “roaming” ATA registered to another proxy through an Internet connection provided by a hotel. If a user is registered with only one proxy server, the proxy selection unit 622 identifies the recipient's registered proxy from the recipient's user identifier and hands the call request to the recipient's registered proxy. If the recipient is registered with multiple proxies, the proxy selection unit sends a query to all registered proxies and hands the call request to one that answers positively. As will be described below, after a connection has been established, both the initiating proxy and the recipient's proxy stay connected and form part of the media stream path 134 during the telephone call.

The billing unit 624 keeps track of connection data for billing purposes. Connection data generally include timing data related to a call, such as starting time, duration and ending time of a call, or whether the call utilizes a PSTN termination or is entirely a VoIP call.

The central management server 602 captures and manages user data and allows an administrator to monitor and manage the VoIP system from a central location. The management server may be implemented as an Element Management System (EMS), which includes an end user access unit 626, a management unit 628, and a control unit 630.

The end user access unit 626 provides a user web portal or other suitable end user interface for an end user to access the system and user data. All user data entered through the user web portal, such as user's real name and billing information, user profile data, are captured by central management server 602 and forwarded to its control unit 630. User profile includes user's unique user identifier, password, MAC address of a user's telephony interface device, a user's PSTN phone number or mobile phone number etc. In general, when a new user account is created, a unique user identifier is created and assigned to the new user. The new user's PSTN telephone number as well as the new user's ATA identification information, such as its MAC address, are then associated with the unique user identifier. Other user information, such as the user's mobile phone number, may also be recorded and then associated with the user's unique user identifier. The user data may be stored in user profile database 606. The control unit 630 formats, i.e., manipulates and transforms raw data captured into a suitable format and sends the formatted data to databases for storage and subsequent retrieval.

The management unit 628 provides a management web portal (not shown), or other suitable interface. An administrator can gain access to central management server 602 through a management web portal. The management unit 628 allows an administrator to create a new user account when a customer subscribes to the VoIP services and register a new user.

The control unit 630 is connected to the user profile database 606, LCR database 608 and proxy registration database 610 and provides an interface to these databases. Additionally, the control unit 630 may communicate with network elements such as routers, switches, proxy servers, to gather and monitor network traffic information. The management unit 628 is connected to the control unit 630. This allows an administrator to review network traffic data gathered by the control unit 630 and manage and review data stored in the user profile database 606, LCR database 608 and proxy registration database 610, and thereby manage and monitor the system, such as network usage or total number of subscribers currently on-line, from a centralized location.

The provisioning server 314 provides provisioning services to ATAs, or any telephony interface devices, provisioned by the system 600. A provisioning server 314 may be divided into three major function units, provisioning unit 632, ATA authentication unit 634 and ATA registration unit 636. Upon the provisioning unit 632 receiving a provision request from an ATA, the request is parsed to extract user information from the request. Further user information is requested from the ATA if necessary. The ATA authentication unit 634 uses the user information provided and further authentication data retrieved from user profile database 606 to authenticate the ATA and confirm that the ATA belongs to a registered user. The user information and authentication data required vary with the security level desirable. For example, the ATA may be first authenticated on the basis of user identifier and a matching password provided by the ATA. The ATA's MAC address provided is then compared with that stored in the user profile database, initially supplied by the registered user when the user first subscribed to the VoIP services, to further confirm that the ATA belongs to the user. After the ATA is authenticated, the ATA registration unit 636 retrieves proxy and other system information from proxy registration database 610 and provides the retrieved information to the ATA. Information retrieved and sent to the ATA includes information for the ATA to connect to all proxy servers of the system, either in the form of a DNS server's IP address or IP addresses of all proxy servers. This will enable the ATA to locate, communicate or connect to any one of the proxy servers when needed.

The ATA registration unit 636 records an ATA's identification information, or a user's unique identifier to register the ATA as one of the ATAs served by the proxy server. The ATA's IP address is also recorded, which will enable the registered proxy server to connect to the ATA when a connection to the ATA is received. Records relating to a registered ATA may be stored in the proxy registration database 610. As described before, the proxy registration database 610 also stores a list of ATAs that are registered to each proxy server 312, as will be described in detail below.

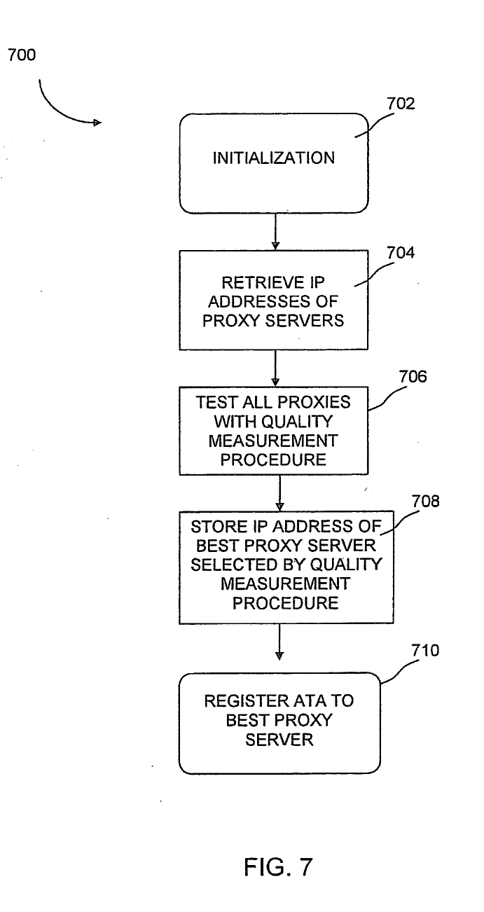

As described earlier, the ATA 500 includes a proxy selector 512 for selecting an optimum proxy server to minimize the impact of public sections on QoS. Often, network latency is a major cause of low quality of VoIP connections. One process of selecting an optimum proxy server is to select the fastest proxy server in terms of response time to a “ping” command. Here, “ping” is a network command that measures return-trip response time to a network query from a querying host to a “pinged” host. Referring to FIG. 7, there is shown a process 700 of an ATA for finding the fastest gateway and registering the ATA with the fastest gateway so located.

The process starts with the initialization of the unit (step 702). At will be understood, step 702 may be a step when the unit is first powered on, re-started, or reset, i.e., when the ATA starts to execute its initialization procedure. During this step, the unit performs a series of pre-determined tests, such as memory test, network connection tests, and the hardware and firmware initialization procedures. Once the ATA is initialized, the ATA retrieves a list of IP addresses of all proxy servers on the dedicated network (step 704). This may be done by querying its allocated domain name server (“DNS”) for srv=sip on the VoIP service provider's domain. Alternatively, if the IP addresses are already stored on a memory device built into the ATA, the addresses may be read from the memory device directly. Next, the proxy selector 512 executes a quality measurement procedure to find the best proxy server available (step 706). As described earlier, a number of network and VoIP analysis tools can be used to determine the connection and data transmission quality from the ATA to each of the proxies. The quality measure may be based on, for example, network latency, data drop rate, number of hops to a particular proxy, among others.

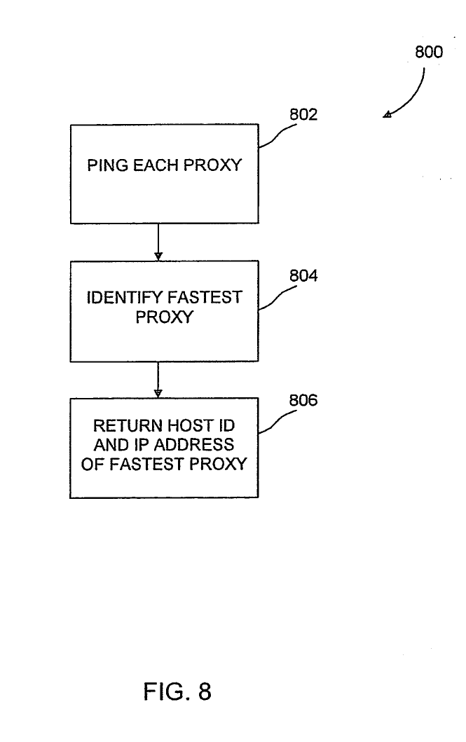

FIG. 8 is a flow chart showing one exemplary procedure 800, a latency procedure, for finding the fastest proxy server. The proxy selector first pings each of the proxy servers (step 802) and records lapsed time required for each proxy server to respond. As only the fastest proxy is of interest, the proxy selector does not need to wait for responses from all proxy servers. Instead, the proxy selector only needs to wait sufficiently long so that the fastest responding proxy server can be identified. At step 804, the proxy selector identifies the proxy server that responded the fastest, for example, by its IP address or its hostname. Next, at step 806, the identity of the fastest gateway (typically its hostname), together with its IP address, is returned for registering the ATA with the fastest proxy server.

As will be appreciated, the procedure for identifying a “best” proxy server is not limited to the latency procedure 800 described above and a “best” proxy server can be identified using any other suitable or appropriate criteria. For example, at step 802, instead of pinging each proxy server, a trace route command may be issued to determine the number of hops, i.e., number of intermediate relaying computers, from the ATA to each of the proxy servers. It will then be the number of “hops” that are recorded and compared at step 806. The “best” proxy server determined according to this modified procedure, a “hop” procedure, will then be the proxy server that has the smallest number of hops from the ATA. Of course, as can be appreciated, many other criteria, such as testing for packet loss, jitter or other undesirable network problems, may be devised to locate a “best” proxy server. Furthermore, it is not always necessary to test and measure the service quality each time a proxy is selected. The system may also be configured to use certain default rules to select a suitable or “best” proxy. For example, in a geographical region with a relatively small number of subscribers, the local proxy server may always be the best proxy and will be identified as the “best proxy” until the number of local subscribers or the local proxy's traffic load reaches a threshold.

Once a “best” proxy server is found or identified, the ATA records the proxy server's IP address (step 708) as the IP address of the connection node for connection to the dedicated network 104. In other words, the proxy server so found will be the ingress gateway to the dedicated network 104 when the ATA initiates a call. The ATA also registers itself with the fastest gateway (step 710). This association between the ATA and the registered proxy server is stored in a central database, the proxy registration database 610. Of course, storing this association in a central database is for convenience only. Functionality of such a database may be provided by distributed databases. For example, each proxy server may also maintain its own database of ATAs registered to it.

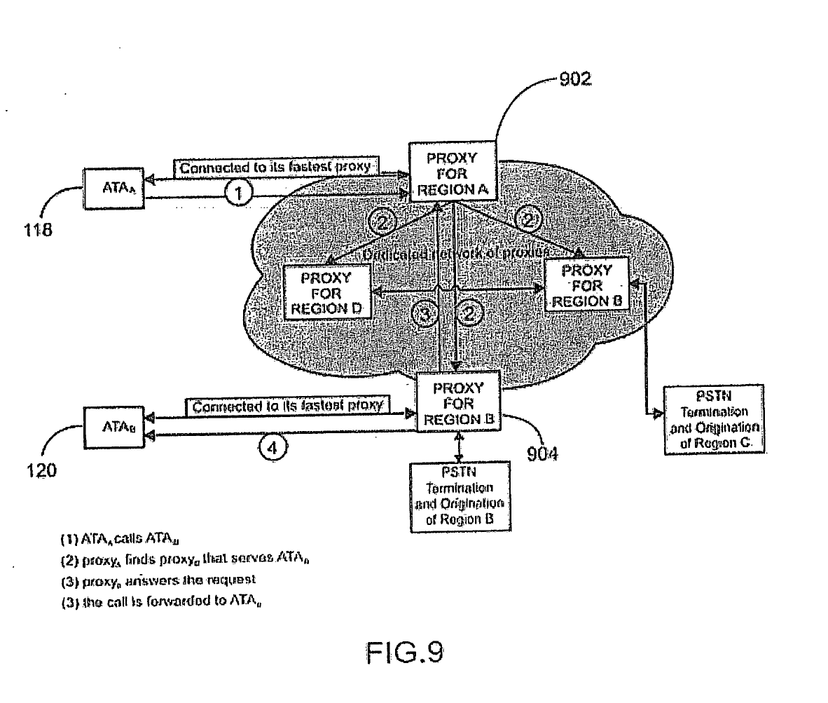

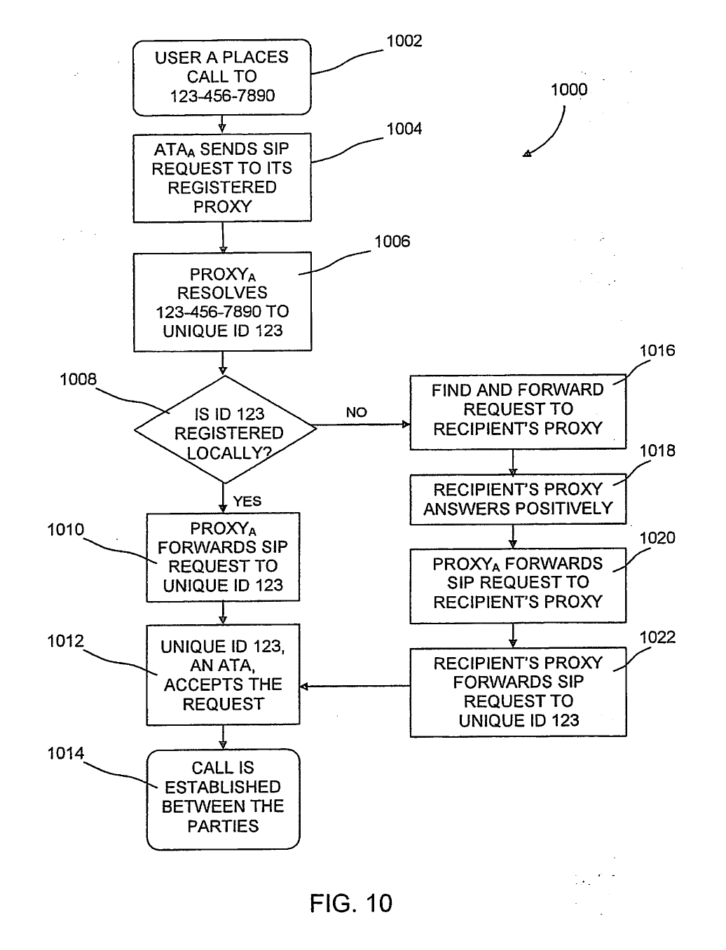

Referring to FIGS. 9 and 10, there is shown a process of connecting an initiating ATA 118 to a receiving ATA 120. A user, in this case, a caller, places a VoIP telephone call to a recipient, whose PSTN phone number is 123-456-5678 (step 1002). This causes the initiating ATA 118 to send a connection request, such as a SIP request, to the proxy server to which it is registered (step 1004; also shown as event “(1)” in FIG. 9). As described earlier, the proxy server to which an ATA is registered is usually the fastest gateway. As this information is generally aged, that is, is as current as the latest registration time, the initiating ATA 118 may execute a latency procedure 800 to dynamically determine the fastest gateway. In any case, whether a proxy server is determined as the “best” at the time of registering the initiating ATA 118 or dynamically, the initiating ATA connects to the best or fastest proxy server 902 and sends the connection request to it.

The fastest proxy server 902 resolves the phone number to a unique user identifier (step 1006). This may be achieved, for example, by looking up the phone number in the user profile database 606 and finding the corresponding user identifier. Once the telephone number is resolved to a unique user identifier, the fastest proxy server 902 examines if the resolved unique user identifier corresponds to an ATA (step 1008) registered locally to the proxy server itself. If so, the proxy server forwards the SIP request to the ATA corresponding to the unique identifier, i.e., the destination ATA 120 (step 1010). The destination ATA 120 accepts the SIP request (step 1012) if it is available, for example, not in the middle of another phone conversation. Subsequently, a connection for the VoIP call is established (step 1014) from the initiating ATA 118 to the fastest proxy server 902 and then to the destination ATA 120, first for signaling the call to the recipient and then for transmitting the voice data when the recipient answers the call.

If the unique user identifier does not correspond to any ATA registered locally to the fastest proxy server, the proxy server identifies the recipient proxy server 418 by either querying the proxy registration database 610, based on the recipient's user identifier. Typically, a user is registered to one proxy server, in which case the recipient's proxy server can be identified using the recipient's user identifier. A user may also have multiple ATAs and therefore may be registered to several proxy servers, in which case all these registered proxy servers will be identified as the recipient's proxy servers based on the recipient's user identifier alone. The caller's proxy server either forwards the connection request to the recipient's only registered proxy server, or forks the connection request to all registered proxy servers on the dedicated network 104 if the recipient is registered to more than one proxy server (step 1016; also shown as event “(2)” in FIG. 9). If there is only one registered proxy server, the only registered proxy server will answer positively if the recipient's ATA is available. If the recipient is registered to multiple proxy servers, one of them will answer positively, if the destination ATA 120 registered to that proxy server is available. If at least one proxy server answer positively to the querying proxy server 902 (step 1018; also shown as event “(3)” in FIG. 9), the querying proxy server 902 then forwards the connection request to the answering proxy server 904 that answered positively (step 1020), who will in turn forward the SIP request to the destination ATA 120 (step 1022). The destination ATA will answer, i.e., accept the request so forwarded (step 1012). Subsequently, a connection from the initiating ATA 118 to the destination ATA 120, via querying proxy server 902 and answering proxy server 904, first for signaling the call to the recipient and then for transmitting the voice data when the recipient answers the call (step 1016; also shown as event “(4)” in FIG. 9). After the connection is established, the connection through the querying proxy server 902 and the answering proxy server 904 is maintained during the call to provide the required media stream path 134.

As will be appreciated, although a connection process is described with reference to connecting two ATAs, the process 1000 can be appropriately modified for connecting an initiating ATA to a POT. For example, if no proxy server answers positively after the initiating proxy server has forwarded or forked the connection request, the failure may be notified to the initiating proxy server.

This failure may be due to one of two causes. One is that the telephone number corresponds to a POT telephone number, not any ATA. The other is that the proxy server serving the recipient ATA is momentarily out of service. In either case, the system may identify and select a proxy server that is connected to at least one PSTN termination gateway. The connection request can then be forwarded to this proxy server so that the telephone call can be completed. Preferably, the PSTN termination gateway serves an area that is geographically close to the location of the POT telephone number, so that long distance telephone expenses can be avoided. Such a connection corresponds to that shown in FIG. 4B.

Various embodiments of the invention have now been described in detail. Those skilled in the art will appreciate that numerous modifications, adaptations and variations may be made to the embodiments without departing from the scope of the invention. Since changes in and or additions to the above-described best mode may be made without departing from the nature, spirit or scope of the invention, the invention is not to be limited to those details but only by the appended claims.

What is claimed is:

1. A system for providing VoIP services in a network of interconnected telecommunication networks for a caller to carry out telephony communications with a recipient, the system comprising:
a plurality of interconnected connection nodes forming a dedicated network, each of said connection nodes being connected to at least one other connection node with a data communication link meeting a transmission quality standard and being a member of at least one of said telecommunication networks;
an initiating telephony interface device for the caller and a receiving telephone interface device for the recipient for carrying out the telephony communications through a media stream path including a middle segment through said dedicated network;
a first connection node selector for selecting a first connection node from said plurality of connection nodes, a first segment of said media stream path between said first connection node and said initiating telephony interface device satisfying a first quality criteria; and
a second connection node selector for selecting a second connection node from said plurality of connection nodes, a second segment of the media stream path between said second connection node and said receiving telephony interface device satisfying a second quality criteria,
wherein said media stream path comprises said first segment, said middle segment and said third segment.

2. The system of claim 1, further comprising:
a database for storing user account information, said user account information including unique user identifiers for uniquely identifying said caller and said recipient.

3. The system of claim 2, wherein at least one of said unique user identifiers is associated with a corresponding user's PSTN telephone number.

4. The system of any one of claims 2 to 3, further comprising:
an authentication unit for verifying a user's identity, said authentication unit being communicatively connected to said connection node selector for establishing a VoIP connection upon successful authentication of the caller.

5. A system for providing VoIP services to users in a network of communication networks, the system comprising:
a plurality of interconnected connection nodes forming a dedicated network, each of said connection nodes being connected to at least one other connection node with a data communication link meeting a transmission quality standard and being a member of at least one of said telecommunication networks;
a caller ATA for requesting a VoIP session, said caller ATA being connected to a first communication network of said communication networks;
a receiver ATA for receiving a VoIP request, said receiver ATA being associated with a unique receiver identifier;
a database for storing receiver account information, said receiver account information including records of said unique receiver identifier,
a caller connection node selector for selecting a first connection node from said plurality of connection nodes, a first segment of said media stream path between said first connection node and said caller ATA satisfying a first quality criteria; and
a forwarding connection node selector for selecting a forwarding connection node from said plurality of connection nodes, a second segment of the media stream path between said forwarding connection node and said receiver ATA satisfying a second quality criteria, said second connection node having a registry identifying said receiver ATA to be registered with said forwarding connection node.

6. The system of claim 5, wherein a second media data connection between said receiver ATA and said second connection node satisfies said quality criteria.

7. A method of providing VoIP services to users in a network of interconnected telecommunication networks, said network having a dedicated network formed from a plurality of connection nodes interconnected with communications links, the communication links meeting a predetermined quality standard, each of said plurality of connection nodes being members of at least one of said telecommunication networks, the method comprising the steps of:
receiving a request for establishing a VoIP session from a caller telephony interface device, said VoIP session request including a receiver identifier for uniquely identifying a recipient,
selecting a first connection node from said plurality of connection nodes, a first data connection between said first connection node and said caller telephony interface device satisfying a first quality criteria,
identifying a second connection node among said plurality of connection nodes, a second data connection between said second connection node and a recipient telephony interface device satisfying a second quality criteria, a communication link between said first connection node and said second connection node forming an intermediate data connection; and
establishing the VoIP session between said caller telephony interface device and said recipient telephony interface device, said the VoIP session being carried out over a media connection path formed from said first data connection, said intermediate data connection and said second data connection.

8. A method of providing VoIP services to users in a network of interconnected telecommunication networks, said network having a dedicated network formed from a plurality of connection nodes interconnected with communications links, the communication links meeting a predetermined quality standard, each of said plurality of connection nodes being members of at least one of said telecommunication networks, the users operating telephony interface devices connected to said telecommunication networks, the method comprising the steps of
for each telephony interface device, periodically associating a connection node from said plurality of connection nodes with said telephony interface device, a data connection between said connection node and said each telephony interface device satisfying a first data transmission quality criteria,
upon receiving a request for establishing a VoIP session between a caller and a recipient from a caller telephony device, said recipient being identified by a recipient identifier,
identifying a caller connection node associated with said caller telephony device,
identifying a recipient connection node based on said recipient identifier,
identifying a recipient telephony interface device associated with said recipient node,
establishing a first data connection between said caller telephony: device and said caller connection node, an intermediate connection between said caller connection node and said recipient connection node, and a second data connection between said recipient connection node and said recipient telephony interface device, and
establishing the VoIP session between said caller telephony interface device and said recipient telephony interface device, said the VoIP session being carried out over a media stream path formed from said first data connection, said intermediate data connection and said second data connection.

9. The method of claim 8, further comprising the step of:
storing the associations between each of the telephony devices and the connection nodes in a database,
wherein the steps of identifying the caller connection node and the recipient telephony device includes retrieving association data from the database.
